(19) United States
(12) Patent Application Publication
(10) Pub. No.: US 2002/0050393 A1
(43) Pub. Date: May 2, 2002

(54) Telecommunications cable

(76) Inventor: Koenraad Vermout, Maaseik (BE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/835,320

(22) Filed: Apr. 17, 2001

(30) Foreign Application Priority Data
Apr. 18, 2000 (EP) 00401084.9

(51) Int. Cl. H01B 7/29

(52) U.S. Cl. 174/128.1

(57) ABSTRACT

The invention is directed to a telecommunications cable comprising at least two telecommunications sub-assemblies, each sub-assembly comprising at least one group of at least two signal conductors, said at least one group being surrounded by a conductive shield, and the conductive shields of adjacent sub-assemblies being in electrical contact with each other, wherein said at least one group is surrounded by an insulating medium and wherein each of said conductive shields is made of a layer of conductive material deposited on said insulating medium.

The present invention relates to a telecommunications cable comprising at least two telecommunications sub-assemblies, each sub-assembly comprising at least one group of at least two signal conductors, said at least one group being surrounded by a conductive shield, and the conductive shields of adjacent sub-assemblies being in electrical contact with each other.

### BACKGROUND OF THE INVENTION

Such a telecommunications cable is already known in the art, e.g. from the International Patent Application PCT/US98/08027 (WO 98/48430). In such a cable, the individual telecommunications sub-assemblies need to be separated from each other by shielding means in order to avoid cross-talk and electromagnetic interferences. Therefore, in the cable of this document, four unshielded twisted pairs or telecommunications sub-assemblies are nested in channels formed by fins of a cross-shaped core, the core material being conductive and forming a longitudinal shield, and the core itself is surrounded by a conductive shield. The construction of the cross-shaped shielding core is complex and the corresponding production cost is high.

### OBJECTS AND SUMMARY OF THE INVENTION

An object of the present invention is to provide a telecommunications cable of the above known type but which is easier to manufacture, relatively cheaper in production and in material, and more resistant to cable bending.

According to the invention, this object is achieved by said at least one group being surrounded by an insulating medium and by each of said conductive shields being made of a layer of conductive material deposited on said insulating medium.

In the present invention, because the transmission sub-assemblies are individually shielded by providing a deposited metal layer on an insulation medium surrounding the signal conductors, the cross-shaped shielding core of the cable is no longer necessary. This reduces dramatically the production cost and the complexity of the cable assembly.

In this way, the disadvantages of the above existing solution are solved. Additionally, the conductive material deposition technology allows applying an acceptable metal thickness at a speed of several hundred meters per minute. The deposition can be done either in a separate production step or on-line on the insulation line before the “take-up”. The total insulation process time may so be reduced.

Moreover, owing to the individual shielding of each telecommunications sub-assembly, all these sub-assemblies are protected from mutual cross-talk or any other outside influence.

In a preferred embodiment of the present invention, the cross-section of the telecommunications sub-assemblies has the shape of a portion of a pie. A cable assembly with a circular section can so easily be obtained.

According to the invention, the signal conductors of each group may be twisted inside the insulating medium. They can also be longitudinally spaced and located in parallel with respect to one another.

In another advantageous embodiment, the conductors are embedded within the insulating medium.

When the conductors are located parallel in parallel with respect to one another and embedded within the insulating medium, they are thus regularly spaced, and the twisting of the conductors may no longer be necessary. This also simplifies the production process while maintaining efficient characteristics against cross-talk and electromagnetic interferences owing to the signal conductors being embedded into the insulating medium. This will also give a better guarantee for overall uniformity of the transmission cable and therefore on the transmission properties.

Further characterizing embodiments of the present telecommunications cable are mentioned in the appended claims.

It is to be noticed that the term ‘comprising’, used in the claims, should not be interpreted as being limitative to the means listed thereafter. Thus, the scope of the expression ‘a device comprising means A and B’ should not be limited to devices consisting only of components A and B. It means that with respect to the present invention, the only relevant components of the device are A and B.

### BRIEF DESCRIPTION OF THE DRAWINGS

The above and other objects and features of the invention will become more apparent and the invention itself will be best understood by referring to the following description of an embodiment taken in conjunction with the accompanying drawings wherein:

FIG. 1 shows two signal conductors embedded within an insulating medium surrounded by a conductive shield in order to form a telecommunications sub-assembly for use in a cable according to the invention;

FIG. 2 shows four telecommunications sub-assemblies as of FIG. 1 and arranged so as to form a cable assembly;

FIG. 3 shows an improved version of the cable assembly of FIG. 2.

### MORE DETAILED DESCRIPTION

All the figures show cross-sectional views of a telecommunications cable according to the present invention. Such a telecommunications cable and a cable sub-assembly for use therein will be described below.

The telecommunications sub-assembly 10 shown at FIG. 1 comprises two signal conductors 11 and 12 embedded in parallel in an insulating medium 13 in order to form a balanced transmission pair. The single body insulating material 13 embedding the conductors is preferably polyethylene and the distance between the conductors 11 and 12 is maintained constant along the whole transmission path. The external surface of the so obtained form is covered with a conductive material deposited layer 14 uniformly applied through e.g. plasma deposition. The conductive material is preferably copper [Cu] or aluminum [Al]. The applied thickness should be of several micrometers depending upon the required shielding performance and on the used material.

This layer 14 will act as an electromagnetic shield around the pair of conductors 11 and 12. As a result, the so obtained shielded telecommunications sub-assembly 10 shows efficient characteristics against cross-talk and electromagnetic interferences, even at relatively high frequencies, although there is no need to twist the signal conductors inside the embedding insulating medium 13. The choice of material used for the conductive layer 14, its thickness and uniformity influence the shielding efficiency. For example, the applied layer 14 should minimally be sufficient to meet the IS011801 Cat.7 cross-talk specification.

By use of a metal plasma-deposit conductive layer 14, a relatively costly production step is avoided. However, other known deposition techniques may be used without going out of the scope of the present invention, as e.g. a sputtering-deposition or ion-deposition techniques.

The current plasma deposition technology allows applying the requested thickness at a speed of several hundred meters per minute. The deposition can be done in a separate production step or on-line on the insulation line before the “take-up”. By making the sub-assembly in one production step on the insulation line, the total insulation process time will be reduced, and the pairing of the individual wires is not necessary. This will also give a better guarantee for overall uniformity and therefore transmission properties.

The cross-section of the telecommunications sub-assembly 10 substantially has the shape of a portion of a pie.

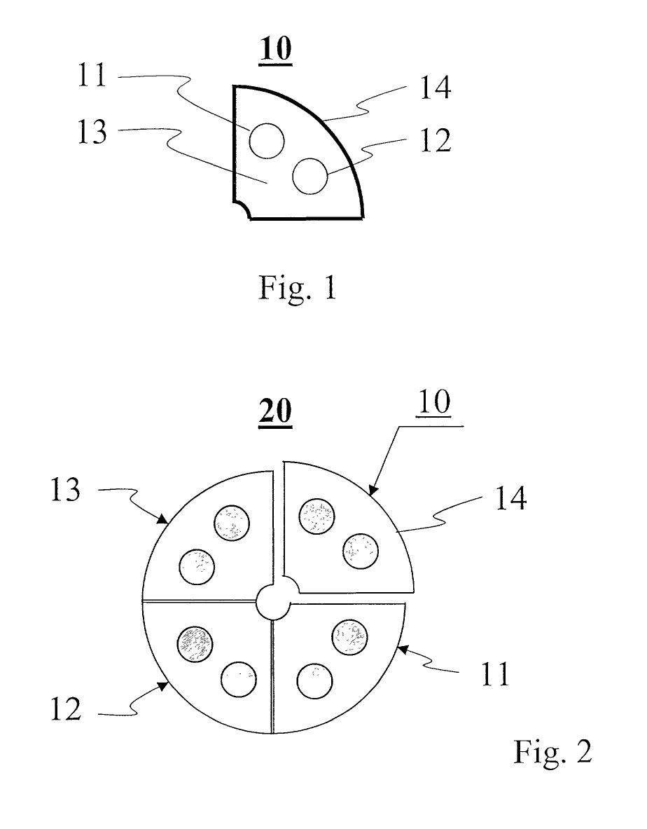

Several, e.g. four, individually embedded shielded pairs 11, 12, 13, all similar to the transmission cable 10, are arranged in order to form a cable 20 as shown at FIG. 2. In this cable 20, the telecommunications sub-assemblies 10 to 13 fit together with their metal plasma-deposit conductive shields, as 14, into electrical contact with each other. The resulting cable assembly 20 has a circular cross-section.

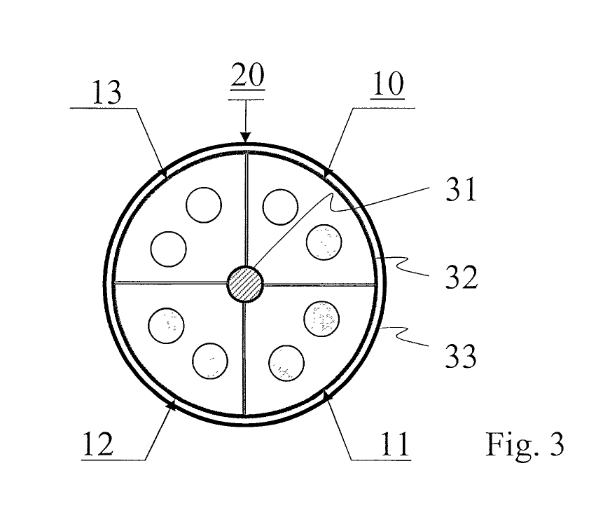

In a preferred embodiment, the cable assembly 20 is provided with a central channel adapted to receive one or more drain wires 31 as shown at FIG. 3. The drain wire 31 is into electrical contact with the conductive shields of all the telecommunications sub-assemblies 10 to 13.

The cable 20 further has an external metallic shield 32 surrounding the telecommunications sub-assemblies 10, 11, 12 and 13, as shown at FIG. 3. The external metallic shield 32 is constituted by a metallic tape or braided wires applied around the cable core and into electrical contact with the conductive shields, as 14, of all the sub-assemblies.

It is to be noted that the flexibility of the cable 20 will be improved if the transmission cables 10, 11, 12 and 13 are helicoidally arranged.

This also facilitates the application of a wrapped metallic tape around the cable.

An extruded outer jacket 33 protecting and maintaining together the sub-assemblies 10 to 13, with or without the external metallic shield 32, finally covers the cable 20.

It is to be noted that in the above description reference is made to telecommunications sub-assemblies with a pair of signal conductors. This is however not a limitation of the invention which can easily be extended to cables with groups of more than two signal conductors in each sub-assembly.

The indicated amount and shape of individually shielded telecommunications sub-assemblies forming the cable is also not a limitation of the invention.

Depending on the shape of the cross-section of each sub-assembly, more or less than four sub-assemblies may be used to form the cable according to the invention.

Moreover, all the sub-assemblies forming the cable need not to have a same section, or a section having the shape of a portion of a pie.

Besides, even if the cable and sub-assemblies of the invention have been described as containing parallel conductors embedded in an insulating medium, the invention also applies to such cables and sub-assemblies in which the conductors are twisted in the form of pairs or quads, and the twisted or parallel conductors need not necessarily be embedded in the insulating medium, as such a medium may only surround them.

While the principles of the invention have been described above in connection with a specific embodiment, it is to be clearly understood that this description is made only by way of example and not as a limitation on the scope of the invention, as defined in the appended claims.

1. A telecommunications cable comprising at least two telecommunications sub-assemblies, each sub-assembly comprising at least one group of at least two signal conductors, said at least one group being surrounded by a conductive shield, and the conductive shields of adjacent sub-assemblies being in electrical contact with each other,
wherein said at least one group is surrounded by an insulating medium and wherein each of said conductive shields is made of a layer of conductive material deposited on said insulating medium.

2. A telecommunications cable according to claim 1, wherein the cross-section of the telecommunications sub-assemblies has a shape of a portion of a pie.

3. A telecommunications cable according to claim 1, the cable being provided with a central channel adapted to receive at least one drain wire that is into electrical contact with the conductive shields of the telecommunications sub-assemblies.

4. A telecommunications cable according to claim 1, having an external metallic shield surrounding the plurality of telecommunications sub-assemblies and being into electrical contact with the conductive shields of said sub-assemblies.

5. A telecommunications cable according to claim 1, having an outer jacket covering the plurality of telecommunications sub-assemblies.

6. A telecommunications cable according to claim 1, wherein said signal conductors of each group are twisted.

7. A telecommunications cable according to claim 1, wherein said signal conductors of each sub-assembly are longitudinally spaced and located in parallel with respect to one another.

8. A telecommunications cable according to claim 1, wherein said conductors are embedded in said insulating medium.

9. A telecommunications cable according to claim 1, wherein said layer of conductive material is chosen among a plasma-deposited layer, a sputtering-deposited layer and an ion-deposited layer.

10. A telecommunications cable according to claim 1, wherein the conductive material of said layer is chosen among copper and aluminum.

11. A telecommunications cable according to claim 1, wherein said insulating medium is polyethylene.
